(19) United States
(12) Patent Application Publication
(10) Pub. No.: US 2025/0292024 A1
(43) Pub. Date: Sep. 18, 2025

(54) AUTOMATIC DETERMINATION OF CUSTOMER SERVICE RESOLUTION STATUS AND EXPLANATION

(71) Applicant: Verint Americas Inc., Alpharetta, GA (US)

(72) Inventors: Shmuel LONDNER, Tel Aviv (IL); Karni GILON, Herzliya (IL); Ingrid VELLEINE, Herzliya (IL)

(21) Appl. No.: 18/602,530

(22) Filed: Mar. 12, 2024

(51) Int. Cl. G06F 40/289; G06F 40/35; G06Q 30/015

(52) U.S. Cl. CPC G06F 40/289; G06F 40/35; G06Q 30/015

(57) ABSTRACT

Certain aspects of the present disclosure provide techniques for providing an issue resolution indication for an interaction. A method includes obtaining an interaction transcript; obtaining a resolution prompt; determining one or more issues presented to the first entity by the second entity, generating, with a first large language model based on the interaction transcript, the one or more issues, and the resolution prompt, one or more issue resolution indications; generating, for each of the one or more issue resolution indications indicating resolved status, a first narrative summarizing one or more actions implemented to resolve the one or more issues; generating, for each of the one or more issue resolution indications indicating unresolved status, a second narrative summarizing a reason the one or more issues are unresolved; and outputting the first narrative or the second narrative with each respective one of the one or more issue resolution indications.

### TECHNICAL FIELD

The present disclosure relates to techniques for providing an issue resolution indication for an interaction.

### BACKGROUND

Customer support services are an obligatory aspect of providing customers services or goods. Customer support services provide a means for a consumer of a service or a good to correspond with a company providing the service or good. Consumers contact customer support services for a wide range or reasons. For example, consumers contact customer support service to make a change to the service, address an issue with the service or good, receive assistance with a service or good, provide feedback to a company, seek information about a service or good, and many other reasons.

Customer support services typically consist of human operated contact centers, or contact centers staffed by a combination of humans and software robots, that correspond with customers via voice call, video call, email, text, instant messages, social messaging, asynchronous chat, or real-time chat. In addition to recording a conversational interaction (also referred to as a session) between a representative of the customer support service and the consumer, other metrics regarding the session may be recorded, in some cases manually by the representative, such as summarizing the interaction. For example, the representative may write up a brief summary of the interaction including whether the issue discussed was resolved, and submit it with the record of the interaction after the session has completed.

Companies providing services and goods and customer support service operators are increasingly interested in utilizing the conversational interactions to glean information about interactions with customers including whether their agents were able to resolve issues a customer has contacted support for and how the issue was resolved or why it was not resolved.

### SUMMARY

One aspect provides a method for providing an issue resolution indication for an interaction, includes obtaining an interaction transcript from the interaction between a first entity and a second entity; obtaining a resolution prompt; determining one or more issues presented to the first entity by the second entity; invoking a first large language model with the interaction transcript, the one or more issues and the resolution prompt; generating, with the first large language model based on the interaction transcript, one or more issue resolution indications each of which correspond to the one or more issues; generating, for each of the one or more issue resolution indications indicating resolved status, a first narrative summarizing one or more actions implemented to resolve the one or more issues; generating, for each of the one or more issue resolution indications indicating unresolved status, a second narrative summarizing a reason the one or more issues are unresolved; and outputting the first narrative or the second narrative with each respective one of the one or more issue resolution indications.

Another aspect provides, an apparatus configured for providing an issue resolution indication for an interaction, comprising: one or more memories comprising processor-executable instructions; and one or more processors configured to execute the processor-executable instructions and cause the apparatus to: obtain an interaction transcript from the interaction between a first entity and a second entity; obtain a resolution prompt; determine one or more issues presented to the first entity by the second entity; generate, with a first large language model based on the interaction transcript, the one or more issues, and the resolution prompt, one or more issue resolution indications each of which correspond to the one or more issues; generate, for each of the one or more issue resolution indications indicating resolved status, a first narrative summarizing one or more actions implemented to resolve the one or more issues; generate, for each of the one or more issue resolution indications indicating unresolved status, a second narrative summarizing a reason the one or more issues are unresolved; and output the first narrative or the second narrative with each respective one of the one or more issue resolution indications.

Another aspect provides, a method for providing an issue resolution indication for an interaction, includes obtaining an interaction transcript from the interaction between a first entity and a second entity; obtaining a resolution prompt; invoking a first large language model with a first input comprising at least the interaction transcript; determining, with the first large language model, one or more issues presented to the first entity by the second entity; generating, with the first large language model based on the first input comprising the interaction transcript, the one or more issues, and the resolution prompt, one or more issue resolution indications each of which correspond to the one or more issues, wherein the one or more issue resolution indications indicate at least one of resolved status or unresolved status; and outputting the one or more issue resolution indications.

These and additional features provided by the aspects described herein will be more fully understood in view of the following detailed description, in conjunction with the drawings.

### DESCRIPTION OF THE DRAWINGS

The aspects set forth in the drawings are illustrative and exemplary in nature and not intended to limit the subject matter defined by the claims. The following detailed description of the illustrative aspects can be understood when read in conjunction with the following drawings, where like structure is indicated with like reference numerals.

FIG. 1 schematically depicts an illustrative block diagram of an issue resolution indication process for an interaction.

FIG. 2 depicts example content input to, generated by, and output from the issue resolution indication process.

FIG. 3A depicts a first illustrative implementation of the issue resolution indication process.

FIG. 3B depicts a second illustrative implementation of the issue resolution indication process.

FIG. 4 depicts an illustrative diagram for a process of grouping issue resolution indication narratives using an analytics engine.

FIG. 5 depicts an illustrative visualization of a structured data generated by the analytics engine from the grouping.

FIG. 6 depicts an illustrative flowchart for an example method for determining an issue resolution indication process.

FIG. 7 depicts an illustrative flowchart for another example method for determining an issue resolution indication process.

FIG. 8 schematically depicts an example apparatus for implementing the issue resolution indication process.

### DETAILED DESCRIPTION

Aspects of the present disclosure are directed to techniques for determining whether an issue expressed by a customer to an agent during a customer-agent interaction was resolved (or not). For purposes of explanation of aspects of the present disclosure, the customer-agent interaction is described as a human-to-human interaction. However, it is understood that a customer-agent interaction may be a human customer and an automated agent response engine, such as a ChatBot or an artificial intelligence enabled agent. For example, a customer may call a contact center to change or correct billing contact information associated with an account. Through the interaction, the agent may or may not be able to address the issue of correcting the billing contact information. The techniques described herein ingest the interaction transcript to determine whether the issue was resolved and provide an issue resolution indication. The issue resolution indication may be a binary indication, such as “Yes” indicating the issue was resolved, or “No” the issue was not resolved. In some aspects, the issue resolution indication may be more comprehensive, such that in addition to the binary indication, or absent the binary indication, a narrative summarizing whether the issue was resolved may be generated.

For example, if the issue is determined to be resolved, the narrative may summarize the one or more actions implemented to resolve the one or more issued. For example, if the agent was able to correct the billing contact information associated with the account the customer was calling to fix, the narrative may provide an indication that the issue of correcting the billing contact information was resolved by updating the email address for the account holder. Alternatively, if the issue is determined to be unresolved, the narrative may summarize the one or more issues remaining unsolved and/or the reason why the one or more issues were not resolved. For example, if the identity of the customer was not verified, the narrative may provide an indication that the issue of correcting the billing contact information was not resolved because the account holder's identify could not be verified to make the requested change.

Contact centers and companies desire an ability to identify and determine whether issues that there customers are having with good and services are being resolved, and if not what the reason is for not being able to resolve the issue. Furthermore, identifying the types of issues, frequency of issues, and whether the issues are able to be resolved can provide insights into customer satisfaction, service improvement, quality assurance, and the like. For example, ensuring that issues are resolved promptly and identifying and addressing outstanding concerns can enhance service quality and customer satisfaction. The resolution status of an issue helps pinpoint recurring issues and knowledge gaps in agents, which can guide improvements in support processes and agent training. Performance metrics associated with issue resolution aids in monitoring key performance indicators (KPIs) such as resolution time and first-call resolution rate, thereby facilitating data-driven decisions and support optimization. Monitoring and being able to effect positive change in KPIs can mitigate the risk of customer dissatisfaction and churn by promptly addressing unresolved issues. Furthermore, on a product and service side, the insights offered from unresolved issues can inform product developments, such as product improvements that align offerings with customer expectations.

In addition to a resolution status, the resolution narrative, which provides a summary of the one or more actions implemented to resolve the one or more issues or a reason the one or more issues remained unresolved, provides an additional level of detail that can provide an indication for understanding, learning from, and improving upon the resolution processes within a contact center. For example, the resolution narrative serves as a resource for training agents on resolving similar issues, enables the review and assurance that the resolution follows best practices and meets quality standards, and can facilitate process refinement for quicker, more efficient future resolutions. The refinement of future resolutions can enhance customer experiences and satisfaction with a contact center and a companies' product or service. Refinement is possible because a collection of narratives builds a knowledge base that can be analyzed to identify consistent problem-solving techniques and insights into how to reduce resolution time. Additionally, the generation of narratives provides a traceable record of actions, holding agents accountable and providing insights into agent efficiency and effectiveness for reviews and appraisals. Moreover, the issue resolution indication processes described herein can indicate, through analysis of the data, proactive adjustments to products, services, and processes by grouping and communicating recurring issues and solutions to management and development teams.

The techniques for determining one or more issues in an interaction and providing an issue resolution indication for the interaction provide a technical solution of automating issue resolution analysis for customer-agent interactions that is efficient, accurate, and reduces or eliminates human capital resources that can be better utilized in corresponding with customers and handling their issues. With respect to efficiency and accuracy, the techniques described herein provide a consistent process that can be applied to interaction transcripts recorded from a conversational interaction between two or more entities. In other words, a summary of issue, actions taken, and whether the resolution was resolved does not require recollection of an agent to generate an after-action summary. Rather, the summary of the issue, actions taken, and whether the resolution was resolved is evidence-based from an automated analysis of at least the interaction transcript. In some instances, the interaction transcript may be supplemented with other interaction data, such as what application the agent used during the interaction and/or other resources employed by the agent to resolve or attempt to resolve the issue.

Techniques described herein automate the identification of one or more issues expressed in a recorded conversational interaction and generate an issue resolution indication. The technical solutions described herein leverage the capabilities of large language models by inputting a combination of a recorded conversational interaction (e.g., a transcript of the interaction) with a resolution prompt to determine the one or more issues expressed in the recorded conversational interaction and provide an issue resolution indication that includes at least a binary indication of the resolution status or a resolution narrative. The technical solutions for providing the issue resolution indication for a conversational interaction provide the technical benefit of reducing or eliminating the need for reliance on human intervention in summarizing a customer-agent interaction, which in turn provides more accurate reporting, and an evidence-based, consistent method for determining and providing the issue resolution indication.

The techniques described herein can be implemented in a variety of manners. For example, customer support services, such as contact centers, may implement the techniques to determine near-real-time issues expressed during an interaction with a consumer and provide an issue resolution indication upon conclusion of the interaction or once a resolution is reached during the interaction. The issue resolution indication can be utilized for understanding, learning from, and improving upon the resolution processes within a contact center. In the instance no resolution is indicated, the transcript may be escalated to another customer service agent. The no resolution indication may trigger a flag to be set indicating to the contact center that a follow up with the customer is needed to resolve their issue. Accordingly, the narrative generated regarding why the issue was unresolved can be stored and sent to the agent in advance of a follow up attempt.

### Aspects Related to Providing an Issue Resolution Indication for an Interaction

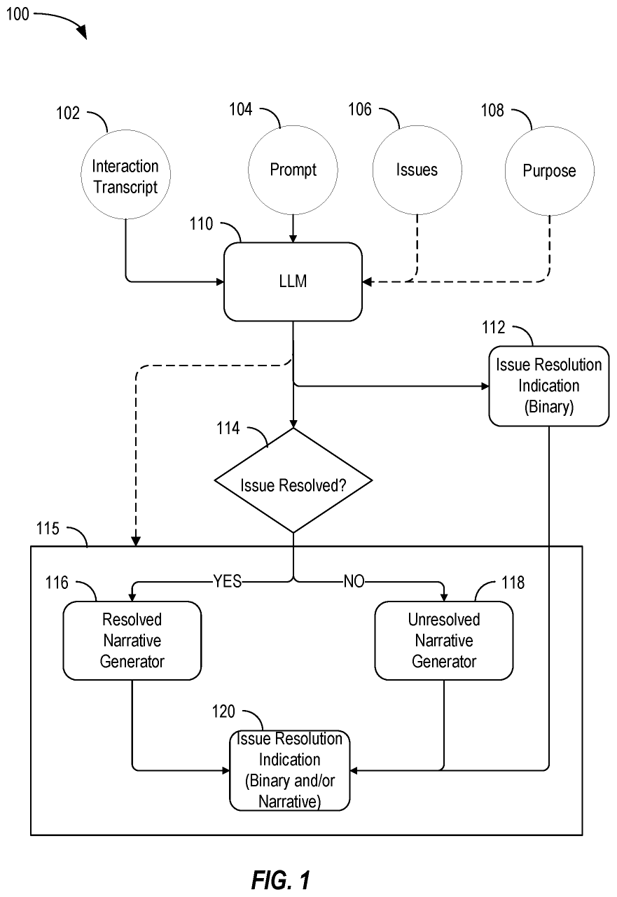

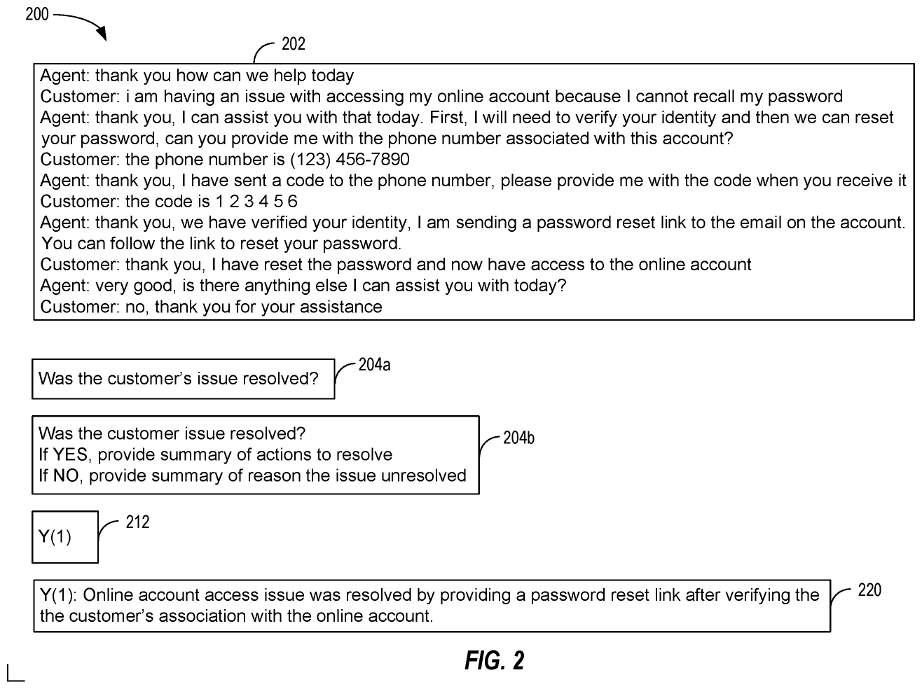

FIG. 1 depicts an illustrative block diagram 100 of an issue resolution indication process. The issue resolution indication process determines one or more issues expressed during a customer-agent interaction and provides an issue resolution indication that includes a binary indication regarding the resolution status and/or a narrative summarizing the actions implemented to resolve the issue or the reason an issue is unresolved. The issue resolution indication process depicted in FIG. 1 will further be described with reference to the example content 200 depicted in FIG. 2.

The issue resolution indication process may be implemented by an apparatus having one or more memories with process-executable instructions, and one or more processors configured to execute the process-executable instructions. A feature of the issue resolution indication process described herein is that the process does not depend on a specific domain or subject matter. In practice, the issue resolution indication process can be utilized by customers across a variety of domains. Additionally, the issue resolution indication process aids in the reduction of maintenance and document management that would otherwise be required to support individual domain analysis of customer-agent interactions and resolution statuses thereof. That is, one or more large language models implemented in aspects of the issue resolution indication process and the prompts may be generic and therefore capable to ingest and process a wide variety of subject matter.

Interaction transcripts 102 are generated from conversational interactions between two or more entities. The conversational interactions between two or more entities may be recorded in the form of audio, video, and/or text data. The data format of the recorded conversational interactions may be structured or unstructured. Therefore, to generate the interaction transcripts, one or more transcription tools, such as an audio-to-text or video-to-text conversion applications, may be used. For example, an example of an interaction transcript 202 is depicted in FIG. 2. The interaction transcript 202 depicted in FIG. 2, is an illustrative example of a customer contacting an agent at a contact center to help with accessing an online account that they are unable to access. In this example, the customer does not recall their password and the agent, through a second factor authentication process, provides the customer with a reset link so they can reset their password and access the online account. The issue of not being able to access an online account is resolved.

The interaction transcript 102 (e.g., the interaction transcript 202 depicted in FIG. 2) may represent an audio-to-text transcription of an audio conversation between an agent and a customer. The interaction transcript 102 can be stored in a data storage device that is accessible via a network by the apparatus or optionally stored in the one or more memories of the apparatus.

The issue resolution indication process implements one or more large language models (LLMs) to analyze the interaction transcript 102 and generate content for the issue resolution indication. Examples of LLMs include, but are not limited to, OpenAI's ChatGPT, NeMO™ LLM from NVIDIA®, LLaMa from Meta®, BERT from Google®, CLAUDE™ from Anthropic A.I., and FLAN-T5 form Google®. The process described herein can implement one or more LLMs currently developed or that may be developed in the future.

The issue resolution indication may include a report with only a binary indication regarding the resolution status of the one or more issues expressed in the interaction transcript 102. In some aspects, the issue resolution indication may include a binary indication and a narrative summarizing the actions implemented to resolve the issue or the reason an issue is unresolved.

The issue resolution indication process may be one of several processes implemented in the analysis of an interaction transcript 102. For example, other processes may be configured to determine the purpose of an interaction and generate a report of the purpose that summarizes one or more intents expressed in the interaction transcript. For example, an intent discovery process for obtaining the purpose corresponding to the interaction transcript may include detecting the one or more intents, with a LLM, from an input comprising at least the interaction transcript and a purpose prompt. Accordingly, the LLM may generate the purpose narrative for the one or more intents expressed in the interaction transcript. An example of the intent discovery process is described in U.S. patent application Ser. No. 18/438,381, which is incorporated herein by reference in its entirety. It is noted that the LLM utilized for the intent discovery process may be a different LLM than the one or more LLMs implemented for the issue resolution indication process described herein.

The issue resolution indication process implements a first LLM 110 configured to receive an interaction transcript 102 and a resolution prompt 104. The resolution prompt 104 may be automatically selected from a predefined list of resolution prompts or may be generated or received, by the system implementing the issue resolution indication process, from a tertiary sources, such as a user or a computing device orchestrating analysis of the interaction transcript. In some aspects, the first LLM 110 is configured to receive one or more issues 106 that have been extracted from the interaction transcript 102. For example, the one or more issues 106 may be extracted from another LLM (e.g., other than the first LLM 110) or another issue extraction process. In some aspects, the first LLM 110 may also be provided with the purpose 108 (also referred to as an intent) corresponding to the interaction transcript 102. For example, a purpose 108 may be a summary or an indication as to the reason for the interaction. The purpose 108 may provide the first LLM 110 with guidance, for example, to extract issues that correspond to the purpose 108. This may be advantageous to include for interactions that may include discussion of more than one issue but which are not related to the overall purpose 108 of the customer's interaction with the contact center. In aspects where the first LLM 110 is provided with the one or more issues 106 and/or the purpose 108, the first LLM 110 may be a small language model (SLM) or a low complexity LLM designed for specific tasks corresponding to determining the issue resolution status and/or generation of narratives corresponding to the resolution status. A SLM or a low complexity LLM refer to types of language models that may be designed to have a smaller codebase than LLMs and/or smaller neural networks compared to LLMs. SLMs and low complexity LLMs may be more readily trained than LLMs and may be tailored to more narrow and specific applications, that potentially make them more practical for companies that require a language model that is trained on more limited datasets, which can be fine-tuned for a particular domain.

To initiate first LLM 110 to perform an operation, generally, a prompt is provided to the first LLM. A prompt is a generated input to which the LLM is meant to respond. Prompts can include instructions, questions, or any other type of input, depending on the intended use of the LLM. How a prompt is written can affect the output that is generated by the LLM model processing the prompt. Accordingly, carefully designed prompts are developed to generate desired outputs. For example, the prompt may be engineered so as to elicit an abstractive description of the issue resolution indication, such as “Was the customer's issue resolved?” as opposed to “Issue resolved?” which is telegraphic speech and would not necessarily cause the LLM to generate an acceptable output.

For the issue resolution indication process, the prompt is a resolution prompt 104. Two example resolution prompts are depicted in FIG. 2. A first resolution prompt 204a recites “Was the customer's issue resolved?” The first resolution prompt 204a, asks a Yes/No question (e.g., requests a binary indication) regarding the issue resolution status based on the interaction transcript 102 processed by the first LLM 110. A second resolution prompt 204b recites “Was the customer issue resolved?; If YES, provide summary of actions to resolve; If NO, provide summary of reason the issue unresolved.” The second resolution prompt 204b asks a Yes-No question and requests a narrative response to a pair of conditional questions based on the Yes-No determination. These are merely two example resolutions prompts and others are possible. Depending on the architecture of the issue resolution indication process, the resolution prompt 104 (e.g., the first resolution prompt 204a or the second resolution prompt 204b) may be provided to one or more different LLMs. For example, the first resolution prompt 204a requesting a binary indication of the issue resolution status may be provided to a first LLM 110, while the second resolution prompt 204b or a similar resolution prompt that requests a narrative regarding the actions take or the reason the issue remains unresolved, may be fed into a different LLM to generate the requested narrative.

For example, the first LLM 110, shown in FIG. 1, may receive the interaction transcript 102 and a resolution prompt 104 such as the first resolution prompt 204a requesting a binary indication of the resolution status. The resolution prompt 104 may alternatively be a second resolution prompt 204b, for example, as depicted in FIG. 2. The first LLM 110 generates the binary indication, for example, in the form of a text value (e.g., “YES” or “NO”), a Boolean value (e.g., TRUE or FALSE), or a bit value (e.g., “0” or “1”) or expressed as a “Y” or “N”, “Yes” or “No”, or another form of binary data representation. A report 112 may be generated and output. For example, the report 112 may be a report 212 as depicted in FIG. 2. For example, a positive response, the report may include “Y,” “1,” or the like as depicted in the illustrative report 212. For a negative response, the report may include “N,” “0,” or the like. Report 212 depicted in FIG. 2 is merely an example. The report provides an issue resolution indication comprising the binary indication of the resolution status. At block 114, the issue resolution indication process determines whether the issue expressed in the interaction transcript was resolved. If the issue is determined to be resolved, “YES” at block 114, then the issue resolution indication process proceeds with generating a resolution narrative at block 116. If the issue is determined to be unresolved, “NO” at block 114, then the issue resolution indication process proceed with generating a resolution narrative at bock 118.

The issue resolution indication process at blocks 116 and 118 may take one of a variety of actions to generate the respective narratives, for example a first narrative providing a summary of the actions taken to resolve the issue or a second narrative providing a summary of the reason why the issue remains unresolved. At block 116, the first LLM 110 may be prompted with a further prompt, such as “Provide a summary of actions to resolve the issue” whereby the first LLM 110 also receives the interaction transcript 102 and optionally the one or more issues 106. In another aspect, at block 116, a second LLM (e.g., different from the first LLM 110), may be prompted with a resolution prompt, such as “Provide a summary of actions to resolve the issue,” whereby the second LLM also receives the interaction transcript 102 and optionally the one or more issues 106. In further aspects, at block 116, a SLM or other generative artificial intelligence (AI) model may be invoked to generate the first narrative. For example, an illustrative first narrative 220 is depicted in FIG. 2. This may be the issue resolution indication generated and output at block 120.

In some aspects, the first LLM 110 may be prompted to provide a resolution narrative directly instead of first generating and outputting an indication regarding whether the issue was resolved or not. For example, the first LLM 110 may be prompt to provide a resolution narrative, thus proceeding directly to block 115 where either one of the respective resolution narratives are generated at block 116 or block 118. In such aspects, a single LLM, for example, the first LLM 110 may be prompted to generate the resolution narrative which is output by block 115.

At block 118, the first LLM 110 may be prompted with a further prompt, such as “Provide a summary of the reason why the issue is unresolved” whereby the first LLM 110 also receives the interaction transcript 102 and optionally the one or more issues 106. In the instance where the first LLM 110 receives the one or more issues 106 as an input, the first LLM 110 may proceed with determining whether the one or more issues 106 were resolved. Conversely, in the instance the first LLM 110 does not receive the one or more issues 106 as an input, the first LLM 110 may first determine the one or more issues 106 present in the interaction transcript 102 and then determine whether the one or more issues 106 were resolved. As noted herein, if a purpose 108 is input into the first LLM 110, the purpose 108 may assist in directing the first LLM 110 with determining the one or more issues 106, since the purpose 108 can provide the first LLM 110 with a targeted topic that the one or more issues 106 may be related to in the interaction transcript 102.

In another aspect, at block 118, a second LLM (e.g., different from the first LLM 110), may be invoked and prompted with a resolution prompt such as “Provide a summary of the reason why the issue is unresolved” whereby the second LLM also receives the interaction transcript 102 and optionally the one or more issues 106. In further aspects, at block 118, a SLM or other generative AI model may be invoked to generate the first narrative It is noted that the LLM invoked by blocks 116 and 118 may be the same LLM or a different LLM. Furthermore, block 116 and 118 may invoke the same SLM or other generative AI model or different ones for generating the respective narratives.

The generated narrative, whether the first narrative from block 116 or the second narrative from block 118, may be compiled with the binary indication from the report 112 and output as issue resolution indication at block 120. In some aspects, the output of the issue resolution indication process, for example, the output generated by the narrative generator(s) at block 116 and/or block 118 may be a string data-type comprising the narrative summary or a tuple of two or more strings. The tuple may comprise a first string comprising the issue and a second string comprising the narrative summary. In an instance where the customer-agent interaction includes several issues, the output of the issue resolution indication process may include a set of tuples, where each tuple comprises two or more strings, for example, as previously described.

An output from block 116 may be a tuple comprising a narrative of the issue and the first narrative. For example, the output may be a tuple comprising two strings “The customer wanted to know how much was left to pay off their phone” and “The agent told the Customer how much was left to pay off their phone” Another example output from block 116 may include a tuple comprising two strings “The customer was looking to get a new phone.” And “The agent gave pricing information for new phones.” An output from block 118 may include, for example, the second narrative as a string reciting “Agent could not solve the technical issue and directed the Customer to a physical store.”

In some aspects, the issue resolution indication generated by the first LLM or any other LLM implemented by the issue resolution indication process may generate a confidence score with the respective output generated by the model. The confidence score is a value the LLM generates indicating a probability that the binary indication and/or the respective narrative regarding the actions taken to resolve the issue or reason why the issue is unresolved is an accurate expression of the resolution status of the issue expressed in the interaction transcript 102. For example, the confidence score may be low if the LLM was required to make more inferences from the interaction transcript than identifying features expressing resolution of the issue, such as a confirmatory statement from the customer thanking the agent for assisting them with resetting their password. The confidence score may be, for example, a value between 0 and 1, or a percentage value between 0% and 100%.

If the confidence score does not meet a threshold, the issue resolution indication process may process the interaction transcript with a larger or different language model. If the confidence score meets or exceeds the threshold, the obtained issue resolution indication can be affiliated with the interaction transcript and stored for use by another process. Other processes may include analytic applications analyzing a corpus of interaction transcripts and issues to determine analytics, such as common issues customer's contact the contact center about, whether those issues are able to be resolved, and the like. For example, the analytic applications analyzing a corpus of interaction transcripts and issues to determine analytics may be executed in an effort to improve contact center issue resolution assistance, product or service improvements, or other desired metric from a company offering a product or service or contact center administrator. In some aspects, if the confidence score does not meet the threshold on two or more models, a mechanism, such as majority voting, can be applied to determine which of the issue resolution indications is the best representation of the resolution in fact. In some aspects, no additional action may be taken when the issue resolution indication process generates the issue resolution indication and the confidence score therefore.

The issue resolution indication process may be implemented in a contact center to provide the agent with near-real-time indications or summaries of issues presented by the customer they are corresponding with. In some aspects an indication, such as a checkmark or color indication associated with each of the one or more issues, may be presented to the agent on a dashboard (e.g., within a graphical user interface) for an active interaction so that the agent can track whether each issue the customer has called about has been resolved and/or whether further follow-up is needed to help resolve the issue. For example, the further follow-up, may be an indication that an issue cannot be resolved because the identity of the customer could not be verified. Accordingly, the agent, upon completion of the call, may provide the customer with next steps, such as have the account holder contact us so we may assist you with resolving the issue.

The issue resolution indication process may output the issue resolution indication to be stored in a memory location for later use or transmitted to a downstream system, such as a customer service center platform conducting conversational interactions with the customer. As described herein, the aforementioned process can be implemented in near-real-time with active customer interactions or as a post-process offline that ingests interaction transcripts and outputs issue resolution indications in narrative form, which provides more accurate reporting, and an evidence-based, consistent method for determining and providing the issue resolution indication. As used herein, the term “near real-time” refers to events occurring at a current time including a margin for processing time to provide generate a response to an input such that the response can be utilized during the occurrence of the event

### Aspects Related to Determining an Issue Resolution Indication

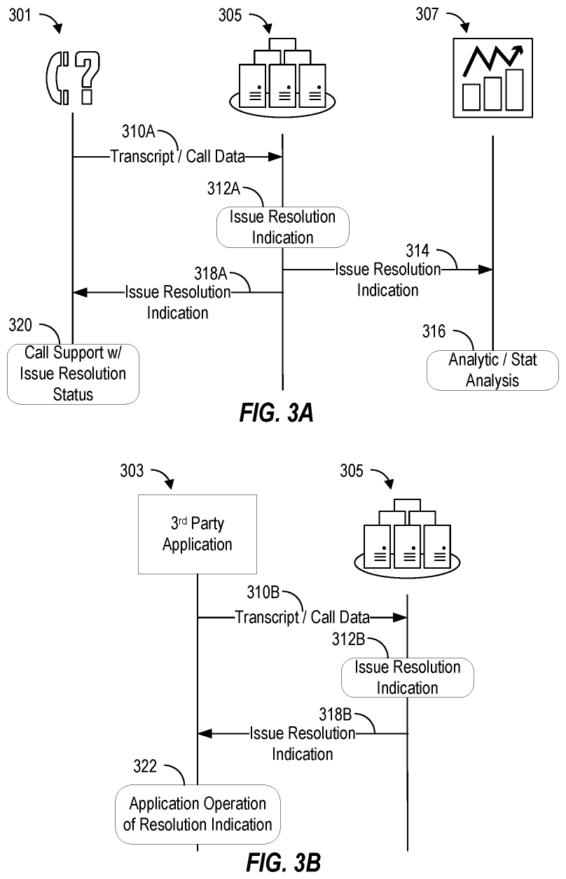

FIGS. 3A and 3B are illustrative implementations of the issue resolution indication process described herein. FIG. 3A depicts a first illustrative implementation of the issue resolution indication process in the context of a customer support service, such as a contact center.

For example, a customer support service 301, such as a contact center, receives calls, chats, or other communications (e.g., via other communication channels) from customers where representatives of the customer support service 301 interact with the customer. The interactions generate transcripts that are transmitted or exported at step 310A to an issue resolution indication system 305. The issue resolution indication system 305 may be an apparatus such as a computing device, server, cloud-based process, or the like configured to implement the issue resolution indication process, for example, as depicted and described with reference to at least FIG. 1. The issue resolution indication system 305 at step 312A executes the issue resolution indication process, for example, as depicted and described with reference to FIGS. 1 and 2, that generates issue resolution indications from the interaction transcripts.

The issue resolution indication system 305 may store the generated issue resolution in one or more memories of the apparatus or output the issue resolution indication to one or more other applications or apparatuses. For example, at step 314, the issue resolution indication system 305 may transmit the issue resolution indication to an analytics engine 307 or other system that compiles and processes a plurality of interaction transcripts and the corresponding issue resolution indications. For example, the analytics engine 307, at block 316, may analyze the received plurality of interaction transcripts and the corresponding issue resolution indication to identify improvements for customer support service operations or for products or services that a consumer is discussing in their interaction with the customer support service 301.

In some aspects, the issue resolution indication system 305 returns the issue resolution indication to a contact center platform of the customer support service 301, at step 318A, for use in near-real-time. In such instances, a representative or multiple representatives interacting with the customer and/or an agent's supervisor may leverage the issue resolution indication to support or help address the issues expressed during the customer's call at step 320. For example, a listing of the issue resolution indications provided to the agent during an interaction may assist the agent in making sure that each issue is resolved or to help identify supporting materials that can be used to resolve the issues. This may be particularly useful, for example, for technical support contact centers where representatives are working with a customer to troubleshoot one or more problems during one call. As such, the issue resolution indication system 305 is able to provide near-real time issue identification from the interaction between the customer and agent and provide the agent with a means for tracking whether the one or more issues raised by the customer have been or need to be resolved. The near-real time issue identification and tracking may be provided to the agent through a visual display or similar interface.

FIG. 3B depicts a second illustrative implementation of the issue resolution indication process implemented as a service that may be accessed by a third-party application 303.

For example, a third-party application 303 may need a tool for detecting issues and their whether the issue has been resolved based on an interaction transcript but does not itself include such a feature. As such, the third-party application 303 at step 310B, similar to step 310A, provides interaction transcripts to the issue resolution indication system 305. The issue resolution indication system 305 at step 312B, similar to step 312A, executes the issue resolution indication process that generates an issue resolution indication from the interaction transcripts. Then, at step 318B, which is similar to step 318A, returns the issue resolution indication to the third-party application 303 for the third-party application's use at step 322. In some aspects, the issue resolution indication process may be configured as an application programing interface (API) enabling a distinct function within the third-party application 303.

### Example Process for Grouping Issue Resolution Indication Narratives

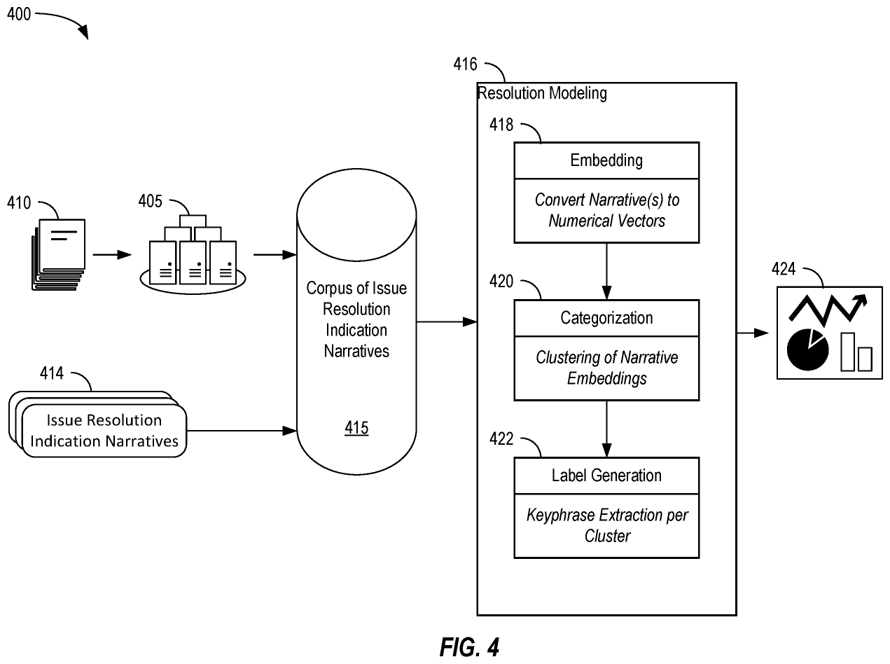

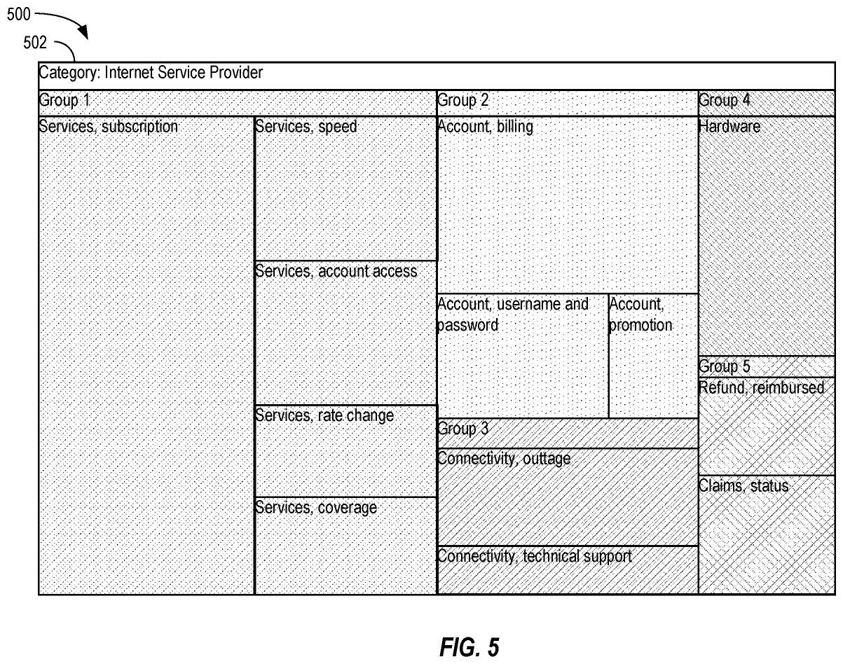

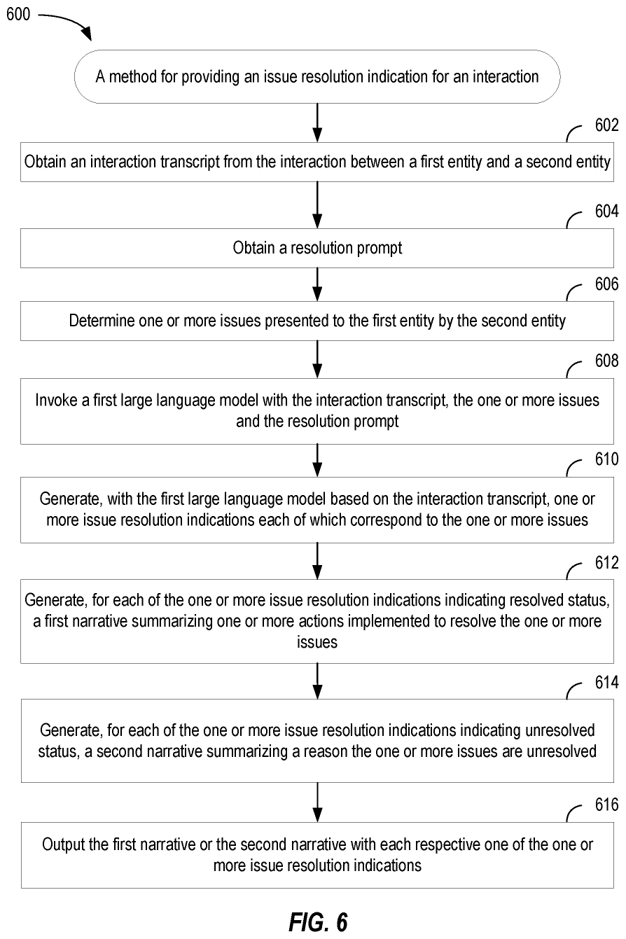

FIG. 4 depicts an illustrative diagram for a process of grouping issue resolution indication narratives. In some aspects of issue resolution indication, additional processes, such as an automatic analysis of issue resolution indication narratives may be implemented. For example, automatic analysis of issue resolution indication narratives may be used to obtain insights into the issue raised, obtain actions taken to resolve issues, and obtain reasons why issues remain unresolved, for example, during an agent and customer interaction. For example, as described herein with reference to step 314 of FIG. 3A the issue resolution indication system 305 may transmit the issue resolution indications including narratives regarding the resolution status to an analytics engine 307. FIG. 5, described further below, provides an example implementation of an analytics engine 307 configured to implement a resolution modeling system 416. The illustrative analytics system 400 includes an issue resolution indication apparatus 405, which may be an implementation of the issue resolution indication system 305 described herein. As described in more detail herein, the issue resolution indication apparatus 405 receives interaction transcripts 410. The issue resolution indication apparatus 405, for example, implementing the issue resolution indication process depicted and described with reference to FIG. 1 and/or the method 600 depicted and described with reference to FIG. 6, generates issue resolution indications for the interaction transcripts 410 received by the issue resolution indication apparatus 405. The issue resolution indication can be stored in a datastore 415 containing a corpus of issue resolution indication narratives generated by the issue resolution indication apparatus 405 or other means. For example, other issue resolution indication narratives 414 may be manually loaded by a user of the system or received from other computing sources and stored in the datastore 415.

The resolution modeling system 416 of the analytics system 400 can retrieve a plurality of narratives from the corpus of issue resolution indication narratives stored in the datastore 415. The resolution modeling system 416 may include multiple tools for aggregating and analyzing issue resolution indication narratives from interactions. Aggregation and analysis of the issue resolution indication narratives can help identify insights into business operations, customer issues with a product or service, and/or potential areas for improvements with products or services by identifying the main problems or issues customers are experiencing, prioritizing support, and/or improving its products or services accordingly. Additionally, tracking issue resolution indication narratives over time can help identify emerging issues, whether issues are able to be resolved, how issues are resolved, anomalies, trends, and change patterns, which can further be used for prioritizing critical issue handling, and product, service, and feature development and improvement planning. Moreover, the resolution modeling system 416 does not need to be prompted to conduct analysis or analytics for a particular product, service, or issue.

The resolution modeling system 416, through aggregation and analysis of the issue resolution indication narratives as described in more detail herein, can identify categories of issues (e.g., as depicted in FIG. 5) and resolution statuses present in the corpus of issue resolution indication narratives and generate groups, which may be hierarchical, so a user, such as a company, can understand the development of issues, topics, and/or trends within the data. In other words, the resolution modeling system 416 is configured to infer groups from the data without prior knowledge or supervision.

FIG. 4 depicts the resolution modeling system 416 including three exemplary components: an embedding component 418, a categorization component 420, and a label generation component 422. The embedding component 418 receives narratives, for example, from the corpus of issue resolution indication narratives (e.g., the datastore 415). The embedding component 418 converts the textual data structure of the narratives into a numerical representation, such as a vector embedding. The conversion by the embedding component 418 prepares the data for various operations that will be performed by one or more machine learning models. As used in herein, the term “vector” refers to a collection of one or more numbers represented in a data type, a container, or the like. For example, each number in a vector represents a magnitude of the vector in a particular dimension. For example, the magnitude may correspond to the number of occurrences of a word or n-gram within a phrase or within a document. In such cases, each dimension of the vector can correspond to a predefined word or n-gram.

In some aspects, the embedding component 418 implements an embedding process configured to prepare the data for processing using, for example, a Sentence Bidirectional Encoder Representation from Transformers (SBERT) model, which is a machine learning framework for natural language processing. Unlike statistical-based text analysis, the SBERT model uses semantic features of text to establish contextual relationships and keyphrase extraction. The SBERT model may be pre-trained on a large corpus of issue resolution indication narratives and then may be fine-tuned on specific types of resolutions or issues, such as those generated within a certain industry or field of service. For example, some industries may utilize highly technical or specific types of communication or vocabulary, which are more accurately identified as known semantic features after fine-tuning (training) the SBERT model.

Once the narratives are embedded using the SBERT model, the resolution modeling system 416 implements the categorization component 420 to categorize each transcript using, in this example, a clustering process. In some aspects, the clustering process may be a Hierarchical Density-Based Spatial Clustering of Applications with Noise (HDBSCAN) model. The categorization component 420 does not require a user to predefine a target or categories sought to be populated by a corpus of issue resolution indication narratives. That is, the categorization component 420, for example, implementing a HDBSCAN model, in an unsupervised process, that discerns categories and sub-categories that are present within embedded corpus of issue resolution indication narratives. In some aspects, a user may provide parameters such as a granularity defining the number of categories and/or sub-categories that are desired from a corpus of issue resolution indication narratives. These parameters may be chosen to maximize the probability to obtain a humanly comprehensible number of categories, for example, 5-7 categories in the case of non-hierarchical clustering, and for example, 20-30 categories, if the clustering is hierarchical.

As categories and sub-categories are discerned by the categorization component 420, overlaps in subject matter of the issue resolution indication narratives may arise. The label generation component 422 of the resolution modeling system 416 is configured to perform a topic identification process based on the SBERT embeddings. The topic identification process may include keyphrase extraction based on vector embedding. The topic identification process is configured to find sub-phrases such as portions of an issue resolution indication in the corpus of issue resolution indication narratives that are the most similar to discerned categories where overlaps exist; and/or a summarization of the inputs identified as part of a group, using the one or more LLMs that creates abstract labels such as “Status Claim.” In some aspects, similar topics that are extracted using the keyphrase extraction process can be merged into super-topics and assigned a label using an abstractive large language model. For example, the abstractive large language model may generate an abstraction as a label for the categories and/or sub-categories which is based on an idea expressed by the plurality of issue resolution indication narratives grouped within a particular category and/or sub-category as opposed to an overlapping phrase recited in the issue resolution indication narratives thereof. Accordingly, the label that is generated for categories and/or sub-categories by the resolution modeling system 416 may be a phrase (e.g., a keyphrase) extracted from the overlap of content in the recitations of issue resolution indication narratives or an abstraction of the issue resolution indication narratives within the categories and/or sub-categories.

The categories and/or subcategories generated by the resolution modeling system 416 may be fed into a visualization component 424. The visualization component 424 generates a visual representation of the topics defined by categories and/or sub-categories of the resolution modeling system 416. For example, the visualizations are graphic representations of the labeled data.

FIG. 5 depicts an illustrative visualization 500 of the structured data generated by the resolution modeling system 416 of the analytics engine. For example, the illustrative visualization 500 includes a treemap 502 that depicts hierarchical (tree-structured) data as a set of nested rectangles. Each branch of the tree is given a rectangle, which is then tiled with smaller rectangles representing sub-branches. The size of the rectangle corresponds to the amount of issue resolution indication narratives that cluster within the labeled category and sub-categories. For example, the treemap 502 depicted in FIG. 5 is for the broad category of “Internet Service Provider” and there are 5 groups, each with sub-categories defined therein. The treemap 502 provides an easily human-interpretable representation of the topics modeled from the corpus of issue resolution indication narratives. A user of the resolution modeling system 416 may select one or more of the rectangles of the treemap 502 to drill-down into the specific issue resolution indication narratives categorized within each.

Example Methods for Providing an Issue Resolution Indication from an Interaction Transcript

FIG. 6 depicts an example method for providing an issue resolution indication for an interaction narrative.

In this example, method 600 begins at step 602 with obtaining an interaction transcript from the interaction between a first entity and a second entity. For example, step 602 may be performed by the issue resolution indication system 305 as described above with reference to FIG. 3.

Method 600 proceeds to step 604 with obtaining a resolution prompt. For example, 604 404 may be performed by the issue resolution indication system 305 as described above with reference to FIG. 3 that is configured to perform the processes corresponding to the interaction transcript 102 as described above with reference to FIG. 1.

Method 600 proceeds to step 606 with determining one or more issues presented to the first entity by the second entity. For example, step 606 may be performed by the issue resolution indication system 305 as described above with reference to FIG. 3 that is configured to perform the processes corresponding to the one or more issues 106 as described above with reference to FIG. 1.

Method 600 then proceeds to step 608 with invoking a first large language model with the interaction transcript, the one or more issues and the resolution prompt. For example, step 608 may be performed by the issue resolution indication system 305 as described above with reference to FIG. 3 that is configured to perform the processes corresponding to the first LLM 110 as described above with reference to FIG. 1.

Method 600 then proceeds to step 610 with generating, with the first large language model based on the interaction transcript, one or more issue resolution indications each of which correspond to the one or more issues. For example, step 610 may be performed by the issue resolution indication system 305 as described above with reference to FIG. 3 that is configured to perform the processes corresponding to the first LLM 110 as described above with reference to FIG. 1.

Method 600 then proceeds to step 612 with generating, for each of the one or more issue resolution indications indicating resolved status, a first narrative summarizing one or more actions implemented to resolve the one or more issues. For example, step 612 may be performed by the issue resolution indication system 305 as described above with reference to FIG. 3 that is configured to perform the processes corresponding to block 116 as described above with reference to FIG. 1.

Method 600 then proceeds to step 614 with generating, for each of the one or more issue resolution indications indicating unresolved status, a second narrative summarizing a reason the one or more issues are unresolved. For example, step 614 may be performed by the issue resolution indication system 305 as described above with reference to FIG. 3 that is configured to perform the processes corresponding to block 118 as described above with reference to FIG. 1.

Method 600 then proceeds to step 616 with outputting the first narrative or the second narrative with each respective one of the one or more issue resolution indications. For example, step 616 may be performed by the issue resolution indication system 305 as described above with reference to FIG. 3 that is configured to perform the processes corresponding to block 120 as described above with reference to FIG. 1.

In some aspect, determining the one or more issues presented to the first entity by the second entity comprises determining the one or more issues with the first large language model based on a first input comprising at least the interaction transcript and a prompt instructing the first large language model to identify the one or more issues.

In some aspects, the method further includes comprising obtaining a purpose corresponding to the interaction transcript, and wherein the first input, to the first large language model for determining the one or more issues, further comprises the purpose.

In some aspects, the purpose comprises a purpose narrative summarizing one or more intents expressed in the interaction transcript, and obtaining the purpose corresponding to the interaction transcript comprises: detecting the one or more intents, with a second large language model, from a second input comprising at least the interaction transcript and a purpose prompt; and generating, with the second large language model, the purpose narrative for the one or more intents expressed in the interaction transcript.

In some aspects, the method further includes determining the one or more issues presented to the first entity by the second entity comprises determining the one or more issues with a third large language model based on a first input comprising at least the interaction transcript.

In some aspects, the method further includes generating the first narrative comprises invoking the first large language model to generate the first narrative, and generating the second narrative comprises invoking the first large language model to generate the second narrative

In some aspects, the method further includes generating the first narrative comprises invoking a second large language model to generate the first narrative, and generating the second narrative comprises invoking the second large language model to generate the second narrative

In some aspects, the method further includes generating the first narrative comprises invoking a second large language model to generate the first narrative, and generating the second narrative comprises invoking a third large language model to generate the second narrative

In some aspects, the method further includes generating, with the first large language model for the one or more issue resolution indications indicating resolved status, a first confidence score corresponding to a probability that the resolved status is in fact indicating an issue corresponding to the issue resolution indication indicating resolved status is resolved; determining whether the first confidence score is greater than or equal to a threshold; storing the issue resolution indication in one or more memories based on the determination that the first confidence score is greater than or equal to the threshold, and generating, with a second first large language model based on the interaction transcript and the resolution prompt, one or more additional issue resolution indication and a second confidence score, based on the determination that the first confidence score is not greater than or equal to the threshold.

In some aspects, the method further includes generating, with the first large language model for the one or more issue resolution indications indicating unresolved status, a first confidence score corresponding to a probability that the unresolved status is in fact indicating an issue corresponding to the issue resolution indication indicating unresolved status is unresolved; determining whether the first confidence score is greater than or equal to a threshold; storing the issue resolution indication in one or more memories based on the determination that the first confidence score is greater than or equal to the threshold, and generating, with a second first large language model based on the interaction transcript and the resolution prompt, one or more additional issue resolution indication and a second confidence score, based on the determination that the first confidence score is not greater than or equal to the threshold.

In some aspects, the method further includes receiving a plurality of first narratives corresponding to a plurality of interactions; converting textual data structure of the plurality of first narratives into numerical vectors embeddings; discerning, with a categorization component processing the numerical vectors, one or more categories that are present within the plurality of first narratives; and labeling, with a label generation component, the one or more categories with a keyphrase.

In some aspects, the keyphrase generated by the label generation component is a phrase extracted from an overlapping portion of the plurality of first narratives categorized within each of the one or more categories.

In some aspects, the keyphrase generated by the label generation component is an abstraction based on the plurality of first narratives categorized within each of the one or more categories.

In some aspects, the method further includes obtaining the interaction transcript comprises: receiving an audio recording of the interaction between the first entity and the second entity; and generating, with a fourth large language model configured for speech recognition processing, the interaction transcript.

In some aspects, the one or more issue resolution indications comprises a Boolean status.

Method 600 provides processes that provide more accurate reporting, and an evidence-based, consistent method for determining and providing the issue resolution indication. The ability to process interaction transcripts, extract issues from the interaction transcripts, and determine the resolution status of each, enables contact centers to provide agents with near-real time issue tracking information. Accordingly, method 600 provides more accurate reporting, and an evidence-based, consistent method for determining and providing the issue resolution indication. For example, as discussed herein, a listing of the issue resolution indications provided to the agent during an interaction may assist the agent in making sure that each issue is resolved or to help identify supporting materials that can be used to resolve the issues. This may be particularly useful, for example, for technical support contact centers where representatives are working with a customer to troubleshoot one or more problems during one call. Note that FIG. 6 is just one example of a method, and other methods including fewer, additional, or alternative steps are possible consistent with this disclosure.

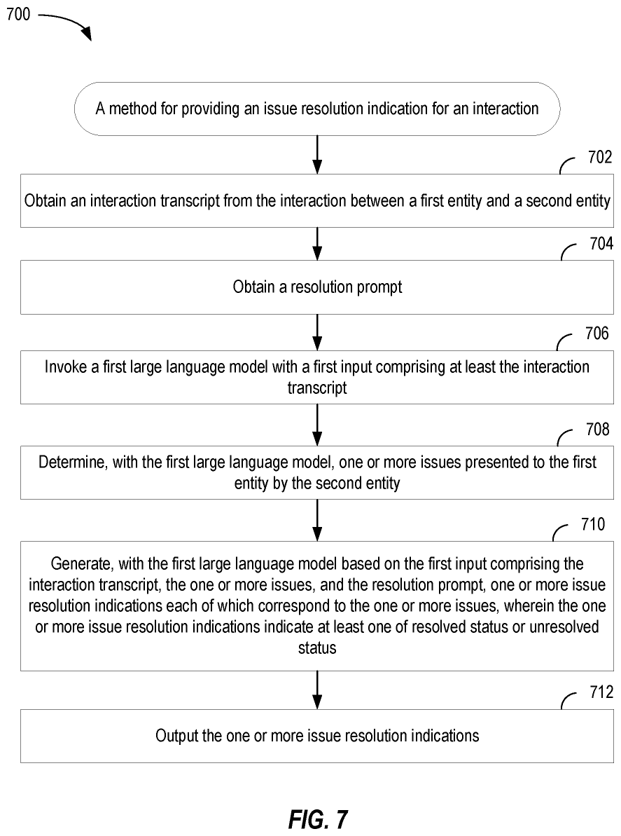

FIG. 7 depicts another example method for providing an issue resolution indication for an interaction.

In this example, method 700 begins at step 702 with obtaining an interaction transcript from the interaction between a first entity and a second entity. For example, step 702 may be performed by the issue resolution indication system 305 as described above with reference to FIG. 3 that is configured to perform the processes corresponding to the interaction transcript 102 as described above with reference to FIG. 1.

Method 700 proceeds to step 704 with obtaining a resolution prompt. For example, 704 404 may be performed by the issue resolution indication system 305 as described above with reference to FIG. 3 that is configured to perform the processes corresponding to the resolution prompt 104 as described above with reference to FIG. 1.

Method 700 proceeds to step 706 with invoking a first large language model with a first input comprising at least the interaction transcript. For example, step 706 may be performed by the issue resolution indication system 305 as described above with reference to FIG. 3 that is configured to perform the processes corresponding to the first LLM 110 as described above with reference to FIG. 1.

Method 700 then proceeds to step 708 with determining, with the first large language model, one or more issues presented to the first entity by the second entity. For example, step 708 may be performed by the issue resolution indication system 305 as described above with reference to FIG. 3 that is configured to perform the processes corresponding to the first LLM 110 as described above with reference to FIG. 1.

Method 700 then proceeds to step 710 with generating, with the first large language model based on the first input comprising the interaction transcript, the one or more issues, and the resolution prompt, one or more issue resolution indications each of which correspond to the one or more issues, wherein the one or more issue resolution indications indicate at least one of resolved status or unresolved status. For example, step 710 may be performed by the issue resolution indication system 305 as described above with reference to FIG. 3 that is configured to perform the processes corresponding to the first LLM 110 and block 116 and 118 as described above with reference to FIG. 1.

Method 700 then proceeds to step 712 with outputting the one or more issue resolution indications. For example, step 712 may be performed by the issue resolution indication system 305 as described above with reference to FIG. 3 that is configured to perform the processes corresponding to block 120 as described above with reference to FIG. 1.

In some aspects, the method further includes generating, with a second large language model, for each of the one or more issue resolution indications indicating resolved status, a first narrative summarizing one or more actions implemented to resolve the one or more issues; generating, with the second large language model, for each of the one or more issue resolution indications indicating unresolved status, a second narrative summarizing a reason the one or more issues are unresolved; and outputting the first narrative or the second narrative corresponding to each respective one of the one or more issue resolution indications.

In some aspects, the method further includes generating, with a second large language model, for each of the one or more issue resolution indications indicating resolved status, a first narrative summarizing one or more actions implemented to resolve the one or more issues; generating, with a third large language model, for each of the one or more issue resolution indications indicating unresolved status, a second narrative summarizing a reason the one or more issues are unresolved; and outputting the first narrative or the second narrative corresponding to each respective one of the one or more issue resolution indications

Similar the discussion above with respect to method 600, method 700 also provides processes that provide more accurate reporting, and an evidence-based, consistent method for determining and providing the issue resolution indication. The ability to process interaction transcripts, extract issues from the interaction transcripts, and determine the resolution status of each, enables contact centers to provide agents with near-real time issue tracking information. Accordingly, method 700 provides more accurate reporting, and an evidence-based, consistent method for determining and providing the issue resolution indication

Note that FIG. 7 is just one example of a method, and other methods including fewer, additional, or alternative steps are possible consistent with this disclosure.

### Example Processing System for Providing an Issue Resolution Indication for an Interaction Transcript

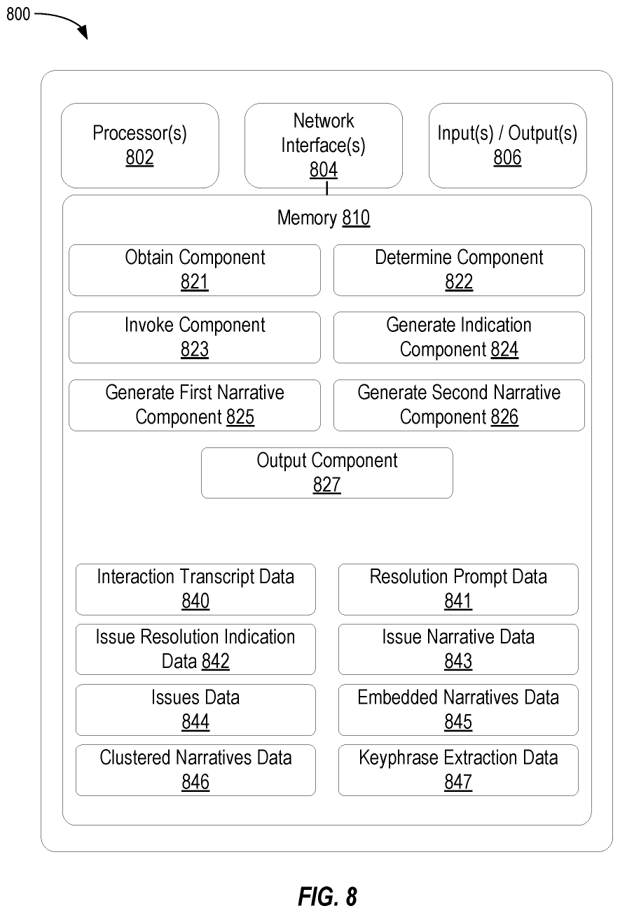

FIG. 8 depicts an example processing system 800 configured to perform the methods described herein. The processing system 800 may be the issue resolution indication system 305 as described herein.

Processing system 800 includes one or more processors 802. Generally, processor(s) 802 may be configured to execute computer-executable instructions (e.g., software code) to perform various functions, as described herein.

Processing system 800 further includes a network interface(s) 804, which generally provides data access to any sort of data network, including personal area networks (PANs), local area networks (LANs), wide area networks (WANs), the Internet, and the like.

Processing system 800 further includes input(s) and output(s) 806, which generally provide means for providing data to and from processing system 800, such as via connection to computing device peripherals, including user interface peripherals.

Processing system further includes a memory 810 configured to store various types of components and data.

In this example, memory 810 includes an obtain component 821, a determine component 822, an invoke component 823, a generate indication component 824, a generate first narrative component 825, a generate second narrative component 826, and a output component 827.

The obtain component 821 is configured to perform processes corresponding to obtaining the interaction transcript 102 and the resolution prompt 104 and optionally processes corresponding to obtaining the purpose 108 depicted and described with reference to FIG. 1 and steps 602 and 604 of the method 600 depicted and described with reference to FIG. 6.

The determine component 822 is configured to perform processes corresponding to determining the one or more issues 106 depicted and described with reference to FIG. 1 and step 606 of the method 600 depicted and described with reference to FIG. 6.

The invoke component 823 is configured to perform processes corresponding to invoking the first LLM 110 depicted and described with reference to FIG. 1 and step 608 of the method 600 depicted and described with reference to FIG. 6.

The generate indication component 824 is configured to perform processes corresponding to invoking the first LLM 110 depicted and described with reference to FIG. 1 and step 610 of the method 600 depicted and described with reference to FIG. 6.

The generate first narrative component 825 is configured to perform processes corresponding to block 116 depicted and described with reference to FIG. 1 and step 612 of the method 600 depicted and described with reference to FIG. 6.

The generate second narrative component 826 is configured to perform processes corresponding to block 118 depicted and described with reference to FIG. 1 and step 614 of the method 600 depicted and described with reference to FIG. 6.

The output component 827 is configured to perform processes corresponding to block 120 depicted and described with reference to FIG. 1 and step 616 of the method 600 depicted and described with reference to FIG. 6.

In this example, memory 810 also includes interaction transcript data 840, resolution prompt data 841, issue resolution indication data 842, issue narrative data 843, issue data 844, embedded narratives data 845, clustered narratives data 846, and keyphrase extraction data 847.

Interaction transcript data 840 corresponds to recorded conversational interactions, which may be transcribed in interaction transcripts for ingestion by the issue resolution indication process depicted and described herein. Resolution prompt data 841 includes the one or more prompts used to initialize the large language models to perform a desired task such as generating issue resolution indication data 842 for the interaction transcript and generate a narrative corresponding to the same. Issue narrative data 843 includes the generated narrative forms of the issue resolution indication.

Issue data 844 corresponds to narratives received from the corpus of issue resolution indication narratives (e.g., the datastore 415) depicted and described herein. Embedded narratives data 845 includes embeddings generated, for example, by the SBERT model of the embedding component 418 as depicted and described herein. The clustered narratives data 846 includes the topics and discerned categories and sub-categories thereof generated by the categorization component 420 as depicted and described herein. The keyphrase extraction data 847 includes the labeled topics that are extracted using the keyphrase extraction process which may also include the super-topics that are assigned a label using the abstractive large language model as depicted and described herein.

Processing system 800 may be implemented in various ways. For example, processing system 800 may be implemented within on-site, remote, or cloud-based processing equipment.

Processing system 800 is just one example, and other configurations are possible. For example, in alternative aspects, aspects described with respect to processing system 800 may be omitted, added, or substituted for alternative aspects.

### Example Clauses

Implementation examples are described in the following numbered clauses:

Clause 1: A method for providing an issue resolution indication for an interaction, comprising: obtaining an interaction transcript from the interaction between a first entity and a second entity; obtaining a resolution prompt; determining one or more issues presented to the first entity by the second entity; invoking a first large language model with the interaction transcript, the one or more issues and the resolution prompt; generating, with the first large language model based on the interaction transcript, one or more issue resolution indications each of which correspond to the one or more issues; generating, for each of the one or more issue resolution indications indicating resolved status, a first narrative summarizing one or more actions implemented to resolve the one or more issues; generating, for each of the one or more issue resolution indications indicating unresolved status, a second narrative summarizing a reason the one or more issues are unresolved; and outputting the first narrative or the second narrative with each respective one of the one or more issue resolution indications.

Clause 2: The method of Clause 1, wherein determining the one or more issues presented to the first entity by the second entity comprises determining the one or more issues with the first large language model based on a first input comprising at least the interaction transcript and a prompt instructing the first large language model to identify the one or more issues.

Clause 3: The method of Clause 2, further comprising obtaining a purpose corresponding to the interaction transcript, and wherein the first input, to the first large language model for determining the one or more issues, further comprises the purpose.

Clause 4: The method of Clause 3, wherein: the purpose comprises a purpose narrative summarizing one or more intents expressed in the interaction transcript, and obtaining the purpose corresponding to the interaction transcript comprises: detecting the one or more intents, with a second large language model, from a second input comprising at least the interaction transcript and a purpose prompt; and generating, with the second large language model, the purpose narrative for the one or more intents expressed in the interaction transcript.

Clause 5: The method of any one of Clauses 1-4, wherein determining the one or more issues presented to the first entity by the second entity comprises determining the one or more issues with a third large language model based on a first input comprising at least the interaction transcript.

Clause 6: The method of any one of Clauses 1-5, wherein: generating the first narrative comprises invoking the first large language model to generate the first narrative, and generating the second narrative comprises invoking the first large language model to generate the second narrative.

Clause 7: The method of any one of Clauses 1-6, wherein: generating the first narrative comprises invoking a second large language model to generate the first narrative, and generating the second narrative comprises invoking the second large language model to generate the second narrative.

Clause 8: The method of any one of Clauses 1-7, wherein: generating the first narrative comprises invoking a second large language model to generate the first narrative, and generating the second narrative comprises invoking a third large language model to generate the second narrative.

Clause 9: The method of any one of Clauses 1-8, further comprising: generating, with the first large language model for the one or more issue resolution indications indicating resolved status, a first confidence score corresponding to a probability that the resolved status is in fact indicating an issue corresponding to the issue resolution indication indicating resolved status is resolved; determining whether the first confidence score is greater than or equal to a threshold; storing the issue resolution indication in one or more memories based on the determination that the first confidence score is greater than or equal to the threshold, and generating, with a second first large language model based on the interaction transcript and the resolution prompt, one or more additional issue resolution indication and a second confidence score, based on the determination that the first confidence score is not greater than or equal to the threshold.

Clause 10: The method of any one of Clauses 1-9, further comprising: generating, with the first large language model for the one or more issue resolution indications indicating unresolved status, a first confidence score corresponding to a probability that the unresolved status is in fact indicating an issue corresponding to the issue resolution indication indicating unresolved status is unresolved; determining whether the first confidence score is greater than or equal to a threshold; storing the issue resolution indication in one or more memories based on the determination that the first confidence score is greater than or equal to the threshold, and generating, with a second first large language model based on the interaction transcript and the resolution prompt, one or more additional issue resolution indication and a second confidence score, based on the determination that the first confidence score is not greater than or equal to the threshold.

Clause 11: The method of any one of Clauses 1-10, further comprising: receiving a plurality of first narratives corresponding to a plurality of interactions; converting textual data structure of the plurality of first narratives into numerical vectors embeddings; discerning, with a categorization component processing the numerical vectors embeddings, one or more categories that are present within the plurality of first narratives; and labeling, with a label generation component, the one or more categories with a keyphrase.

Clause 12: The method of Clause 11, wherein the keyphrase generated by the label generation component is a phrase extracted from an overlapping portion of the plurality of first narratives categorized within each of the one or more categories.

Clause 13: The method of Clause 11, wherein the keyphrase generated by the label generation component is an abstraction based on the plurality of first narratives categorized within each of the one or more categories.

Clause 14: The method of any one of Clauses 1-13, wherein obtaining the interaction transcript comprises: receiving an audio recording of the interaction between the first entity and the second entity; and generating, with a fourth large language model configured for speech recognition processing, the interaction transcript.

Clause 15: The method of any one of Clauses 1-14, wherein the one or more issue resolution indications comprises a Boolean status.

Clause 16: A method for providing an issue resolution indication for an interaction, comprising: obtaining an interaction transcript from the interaction between a first entity and a second entity; obtaining a resolution prompt; invoking a first large language model with a first input comprising at least the interaction transcript; determining, with the first large language model, one or more issues presented to the first entity by the second entity; generating, with the first large language model based on the first input comprising the interaction transcript, the one or more issues, and the resolution prompt, one or more issue resolution indications each of which correspond to the one or more issues, wherein the one or more issue resolution indications comprises at least one of a resolution status or a resolution narrative; and outputting the one or more issue resolution indications.

Clause 17: The method of Clause 16, further comprising: generating, with a second large language model, for each of the one or more issue resolution indications indicating resolved status, a first narrative summarizing one or more actions implemented to resolve the one or more issues; generating, with the second large language model, for each of the one or more issue resolution indications indicating unresolved status, a second narrative summarizing a reason the one or more issues are unresolved; and outputting the first narrative or the second narrative corresponding to each respective one of the one or more issue resolution indications.

Clause 18: The method of Clause 16, further comprising: generating, with a second large language model, for each of the one or more issue resolution indications indicating resolved status, a first narrative summarizing one or more actions implemented to resolve the one or more issues; generating, with a third large language model, for each of the one or more issue resolution indications indicating unresolved status, a second narrative summarizing a reason the one or more issues are unresolved; and outputting the first narrative or the second narrative corresponding to each respective one of the one or more issue resolution indications.

Clause 19: A processing system, comprising: a memory comprising computer-executable instructions; and a processor configured to execute the computer-executable instructions and cause the processing system to perform a method in accordance with any one of Clauses 1-18.

Clause 20: A processing system, comprising means for performing a method in accordance with any one of Clauses 1-18.

Clause 21: A non-transitory computer-readable medium comprising computer-executable instructions that, when executed by a processor of a processing system, cause the processing system to perform a method in accordance with any one of Clauses 1-18.

Clause 22: A computer program product embodied on a computer-readable storage medium comprising code for performing a method in accordance with any one of Clauses 1-18.

### Additional Considerations

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It will be apparent to those skilled in the art that various modifications and variations can be made in the present disclosure without departing from the spirit or scope of the disclosure. Thus, it is intended that the present disclosure cover the modifications and variations of this disclosure provided they come within the scope of the appended claims and their equivalents.

While various aspects of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary aspects, but should be defined only in accordance with the following claims and their equivalents.

What is claimed is:

1. A method for providing an issue resolution indication for an interaction, comprising:
obtaining an interaction transcript from the interaction between a first entity and a second entity;
obtaining a resolution prompt;
determining one or more issues presented to the first entity by the second entity;
invoking a first large language model with the interaction transcript, the one or more issues and the resolution prompt;
generating, with the first large language model based on the interaction transcript, one or more issue resolution indications each of which correspond to the one or more issues;
generating, for each of the one or more issue resolution indications indicating resolved status, a first narrative summarizing one or more actions implemented to resolve the one or more issues;
generating, for each of the one or more issue resolution indications indicating unresolved status, a second narrative summarizing a reason the one or more issues are unresolved; and
outputting the first narrative or the second narrative with each respective one of the one or more issue resolution indications.

2. The method of claim 1, wherein determining the one or more issues presented to the first entity by the second entity comprises determining the one or more issues with the first large language model based on a first input comprising at least the interaction transcript and a prompt instructing the first large language model to identify the one or more issues.

3. The method of claim 2, further comprising obtaining a purpose corresponding to the interaction transcript, and
wherein the first input, to the first large language model for determining the one or more issues, further comprises the purpose.

4. The method of claim 3, wherein:
the purpose comprises a purpose narrative summarizing one or more intents expressed in the interaction transcript, and
obtaining the purpose corresponding to the interaction transcript comprises:
detecting the one or more intents, with a second large language model, from a second input comprising at least the interaction transcript and a purpose prompt; and
generating, with the second large language model, the purpose narrative for the one or more intents expressed in the interaction transcript.

5. The method of claim 1, wherein determining the one or more issues presented to the first entity by the second entity comprises determining the one or more issues with a third large language model based on a first input comprising at least the interaction transcript.

6. The method of claim 1, wherein:
generating the first narrative comprises invoking the first large language model to generate the first narrative, and
generating the second narrative comprises invoking the first large language model to generate the second narrative.

7. The method of claim 1, wherein:
generating the first narrative comprises invoking a second large language model to generate the first narrative, and
generating the second narrative comprises invoking the second large language model to generate the second narrative.

8. The method of claim 1, wherein:
generating the first narrative comprises invoking a second large language model to generate the first narrative, and
generating the second narrative comprises invoking a third large language model to generate the second narrative.

9. The method of claim 1, further comprising:
generating, with the first large language model for the one or more issue resolution indications indicating resolved status, a first confidence score corresponding to a probability that the resolved status is in fact indicating an issue corresponding to the issue resolution indication indicating resolved status is resolved;
determining whether the first confidence score is greater than or equal to a threshold;
storing the issue resolution indication in one or more memories based on the determination that the first confidence score is greater than or equal to the threshold, and
generating, with a second first large language model based on the interaction transcript and the resolution prompt, one or more additional issue resolution indication and a second confidence score, based on the determination that the first confidence score is not greater than or equal to the threshold.

10. The method of claim 1, further comprising:
generating, with the first large language model for the one or more issue resolution indications indicating unresolved status, a first confidence score corresponding to a probability that the unresolved status is in fact indicating an issue corresponding to the issue resolution indication indicating unresolved status is unresolved;
determining whether the first confidence score is greater than or equal to a threshold;
storing the issue resolution indication in one or more memories based on the determination that the first confidence score is greater than or equal to the threshold, and
generating, with a second first large language model based on the interaction transcript and the resolution prompt, one or more additional issue resolution indication and a second confidence score, based on the determination that the first confidence score is not greater than or equal to the threshold.

11. The method of claim 1, further comprising:
receiving a plurality of first narratives corresponding to a plurality of interactions;
converting textual data structure of the plurality of first narratives into numerical vectors embeddings;
discerning, with a categorization component processing the numerical vectors embeddings, one or more categories that are present within the plurality of first narratives; and
labeling, with a label generation component, the one or more categories with a keyphrase.

12. The method of claim 11, wherein the keyphrase generated by the label generation component is a phrase extracted from an overlapping portion of the plurality of first narratives categorized within each of the one or more categories.

13. The method of claim 11, wherein the keyphrase generated by the label generation component is an abstraction based on the plurality of first narratives categorized within each of the one or more categories.

14. The method of claim 1, wherein obtaining the interaction transcript comprises:
receiving an audio recording of the interaction between the first entity and the second entity; and
generating, with a fourth large language model configured for speech recognition processing, the interaction transcript.

15. The method of claim 1, wherein the one or more issue resolution indications comprises a Boolean status.

16. An apparatus configured for providing an issue resolution indication for an interaction, comprising: one or more memories comprising processor-executable instructions; and
one or more processors configured to execute the processor-executable instructions and cause the apparatus to:
obtain an interaction transcript from the interaction between a first entity and a second entity;
obtain a resolution prompt;
determine one or more issues presented to the first entity by the second entity;
generate, with a first large language model based on the interaction transcript, the one or more issues, and the resolution prompt, one or more issue resolution indications each of which correspond to the one or more issues;
generate, for each of the one or more issue resolution indications indicating resolved status, a first narrative summarizing one or more actions implemented to resolve the one or more issues;
generate, for each of the one or more issue resolution indications indicating unresolved status, a second narrative summarizing a reason the one or more issues are unresolved; and
output the first narrative or the second narrative with each respective one of the one or more issue resolution indications.

17. The apparatus of claim 16, wherein to determine the one or more issues comprises determining the one or more issues with the first large language model based on a first input comprising at least the interaction transcript and a prompt instructing the first large language model to identify the one or more issues.

18. A method for providing an issue resolution indication for an interaction, comprising:
obtaining an interaction transcript from the interaction between a first entity and a second entity;
obtaining a resolution prompt;
invoking a first large language model with a first input comprising at least the interaction transcript;
determining, with the first large language model, one or more issues presented to the first entity by the second entity;
generating, with the first large language model based on the first input comprising the interaction transcript, the one or more issues, and the resolution prompt, one or more issue resolution indications each of which correspond to the one or more issues, wherein the one or more issue resolution indications comprises at least one of a resolution status or a resolution narrative; and
outputting the one or more issue resolution indications.

19. The method of claim 18, further comprising:
generating, with a second large language model, for each of the one or more issue resolution indications indicating resolved status, a first narrative summarizing one or more actions implemented to resolve the one or more issues;
generating, with the second large language model, for each of the one or more issue resolution indications indicating unresolved status, a second narrative summarizing a reason the one or more issues are unresolved; and
outputting the first narrative or the second narrative corresponding to each respective one of the one or more issue resolution indications.

20. The method of claim 18, further comprising:
generating, with a second large language model, for each of the one or more issue resolution indications indicating resolved status, a first narrative summarizing one or more actions implemented to resolve the one or more issues;
generating, with a third large language model, for each of the one or more issue resolution indications indicating unresolved status, a second narrative summarizing a reason the one or more issues are unresolved; and
outputting the first narrative or the second narrative corresponding to each respective one of the one or more issue resolution indications.
